(19) United States
(12) Patent Application Publication
(10) Pub. No.: US 2012/0314597 A1
(43) Pub. Date: Dec. 13, 2012

(54) ENHANCED STREAM RESERVATION PROTOCOL FOR AUDIO VIDEO NETWORKS

(76) Inventors: Harkirat Singh, San Jose, CA (US); Soo-Young Kim, Suwon (KR); Jonghwa Kim, Suwon (KR); SeungHwan Kim, Suwon (KR); Ilju Na, Suwon (KR); Jae Min Lee, Suwon (KR); Chiu Ngo, San Francisco, CA (US)

(21) Appl. No.: 13/491,243

(22) Filed: Jun. 7, 2012

Related U.S. Application Data
(60) Provisional application No. 61/494,818, filed on Jun. 8, 2011.

(51) Int. Cl. H04L 12/28; H04L 12/26

(52) U.S. Cl. 370/252; 370/351

(57) ABSTRACT

An enhanced stream reservation protocol comprising a Talker device sending a Stream Reservation Protocol (SRP) Talker Advertise message for streaming data to a Listener device, receiving the Talker Advertise message and checking bandwidth availability on an output port thereof for the streaming. In case of insufficient communication bandwidth, sending a failure message that includes information about available bandwidth from the Talker device to the Listener device. A protocol for communication in a bridged network, comprising a Talker device sending an SRP Talker Advertise message for streaming data to a Listener device. The Talker Advertise message includes communication path information from the Talker device to the Listener device. A communication path from the Talker device to the Listener device is selected based on said path metrics, for streaming data between the Talker device and the Listener device.

### CROSS-REFERENCE TO RELATED APPLICATION

This application claims the benefit of U.S. Provisional Patent Application Ser. No. 61/494,818, filed on Jun. 8, 2011, incorporated herein by reference.

### FIELD OF THE INVENTION

The present invention relates generally to audio video (AV) networks, and in particular to AV streaming in AV networks.

### DESCRIPTION OF RELATED ART

Existing versions of High-Definition Multimedia Interface (HDMI) lack support for bi-directional Audio Video (AV) streaming. On the other hand, Ethernet networks have become ubiquitous in their deployment across corporate and residential markets. In supporting high-bandwidth traffic, these Ethernet networks have benefited from a significant reduction in costs. It is expected that typical home network connections will increasingly support 1000BASE-T, 10 GBASE-T and beyond. Typical network connections include wired and wireless network links.

### BRIEF SUMMARY

The present invention relates to data streaming in AV networks, such as bridged networks. In one embodiment the present invention provides an enhanced stream reservation protocol comprising a Talker device sending a Stream Reservation Protocol (SRP) Talker Advertise message for streaming data to a Listener device, receiving the Talker Advertise message and checking bandwidth availability on an output port thereof for the streaming. In case of insufficient communication bandwidth, sending a failure message that includes information about available bandwidth from the Talker device to the Listener device. In one implementation, receiving the Talker Advertise message further comprises an intermediate bridge device receiving the Talker Advertise message, checking bandwidth availability on an output port thereof for the streaming, and sending a Talker Advertise Failed message with a modified traffic specification to indicate said information about available bandwidth.

In another embodiment the present invention provides a protocol for communication in a bridged network, comprising a Talker device sending an SRP Talker Advertise message for streaming data to a Listener device. The Talker Advertise message includes communication path information from the Talker device to the Listener device. A communication path from the Talker device to the Listener device is selected based on said path metrics, for streaming data between the Talker device and the Listener device.

These and other features, aspects and advantages of the present invention will become understood with reference to the following description, appended claims and accompanying figures.

### BRIEF DESCRIPTION OF THE DRAWINGS

FIG. 1 shows an AV network of bridged AV devices serially connected in which embodiments of the invention can be implemented;

FIG. 2 shows an AV network of bridged AV devices including multiple communication paths, in which embodiments of the invention can be implemented;

FIG. 2A shows an AV network of bridged AV devices including multiple communication paths, implementing enhanced resources reservation for SRP, according to an embodiment of the invention;

FIG. 3 shows a Spanning Tree Protocol (STP) configured over an AV network;

FIG. 4 shows a Next Generation Interface (NGI) Network implementing enhanced resources reservation for SRP, according to an embodiment of the invention;

FIG. 5 shows an enhanced protocol stack for the AV network, according to an embodiment of the invention;

FIG. 6 illustrates successful bandwidth allocation in an AV network;

FIG. 7 illustrates a Talker Advertise Failed message updated by bridges based on available bandwidth in an AV network, according to an embodiment of the invention;

FIG. 8 illustrates a process for enhanced stream reservation including Talker Advertisement processing at an Audio Video Bridging (AVB) bridge in an AVB network, according to an embodiment of the invention;

FIG. 9 shows a process for an enhanced reservation mechanism including Failed Bandwidth indicated to a Talker device via Talker Advertise Failed Message in an AV network, according to an embodiment of the invention;

FIG. 10 illustrates successful bandwidth reservation in an AV network, according to an embodiment of the invention;

FIG. 11 illustrates alternative communication paths between a Talker device and a Listener device in an AV network, according to an embodiment of the invention;

FIG. 12 illustrates other alternative communication paths between a Talker device and a Listener device in an AV network, according to an embodiment of the invention;

FIG. 13 illustrates a message flow in an AV network, including processing of Talker Advertisement messages in an AV network, according to an embodiment of the invention;

FIG. 14 illustrates processing a Talker Advertisement message including additional network resource attributes in an AV network, according to an embodiment of the invention;

FIG. 15 illustrates Listener device processing messages including additional network resource attributes in an AV network, according to an embodiment of the invention;

FIG. 16 illustrates Listener message processing in an AV network, according to an embodiment of the invention;

FIG. 17 illustrates Listener message processing with a backup communication path in an AV network, according to an embodiment of the invention;

FIG. 18 illustrates primary and backup communication paths in an AV network, according to an embodiment of the invention; and

FIG. 19 shows a block diagram of an information processing system comprising a computer system useful for implementing an embodiment of the present invention.

### DETAILED DESCRIPTION OF THE INVENTION

The present invention relates to data streaming in AV networks. Embodiments of the invention provide an enhanced resource reservation scheme for a stream reservation protocol for AV streaming. In one embodiment, the enhanced resource reservation scheme modifies stream reservation protocol of IEEE 802.1Qat, which in one implementation is suitable for Next Generation HDMI Interface applications. The enhanced resource reservation scheme includes support for improved error reporting and overcoming AV network resource changes that may result in streaming quality of service changes.

Audio Video Bridging (AVB) technical standard includes a set of specifications to allow transport of high-quality, time-sensitive AV applications over IEEE 802 bridged local area networks (LANs). IEEE 802.1Qat Stream Reservation Protocol (SRP) specification enables an AVB destination electronic device (commonly known as a Listener) to register a request for delivery of a specified AV stream from an AVB source electronic device (commonly known as Talker) in an AVB network. In addition, an AVB source device may request reservation of network resources, which enables the transmission of a specified AV stream. The SRP defined within the IEEE 802.1 Qat specification provides a mechanism whereby the AVB source device may register a request to reserve network resources (such as bandwidth) within an AVB network to enable the transmission of the specified AV stream. A Listener indicates which data stream is to be received, and a Talker announces a data stream that can be supported by a bridged entity. Network resources are allocated and configured in both the end nodes (e.g., Talker and Listener) of a data stream and the transit nodes (e.g., bridges) along the path for data stream. An end-to-end signaling mechanism to detect the success/failure of the effort is also provided.

SRP registers a stream and reserves the resources required through the entire path taken by the stream. A Talker initiates by sending an SRP Talker Advertise message. AVB intermediate bridges receiving a Talker Advertise message check for bandwidth availability on their output ports. If a bridge has sufficient resources available on that port, then the Talker Advertise message is propagated to the next node. If the resources are not available, rather than propagating the Talker Advertise message, the bridge sends a Talker Failed message. An intermediate bridge receiving a Talker Failed message passes the message out towards the Listener.

The Listener can respond with a Listener Ready message that is forwarded back towards the Talker. Intermediate bridges use the Ready message to maintain the resources needed by the stream and to make the appropriate entries in their forwarding tables to allow the stream to be sent on the port that received the Ready message. When the Talker receives a Ready message, it can start transmitting the stream.

However, conventional IEEE 802.1Qat SRP is a one-way declarative protocol with reservation messages propagated from a Talker towards Listeners. It contains no backward propagated acknowledgement or status report messages. In addition, conventional IEEE 802.1Qat SRP uses a fixed path metric closely tied to IEEE 802.1d Spanning Tree Protocol (STP). This reduces SRP efficiently in properly utilizing available network bandwidth and ensuring high quality AV streaming.

A typical IEEE 802.1AVB network comprises a set of AVB devices, which are collectively referred to as an AVB block or domain. An AVB network may comprise wired or optical local area networks (LANs) and/or wireless LANs (WLANs) such as 802.11ad/ac/a/g/n/ad/ac. Individual AVB devices within the AVB network may include AVB-enabled endpoint devices (e.g., TV, AV Receiver, Desktop/laptop, BlueRay Player, etc.), AVB-enabled switching devices (i.e., AV switches or bridges) within LANs and AVB-enabled access points (i.e., APs) within WLANs. Within the AVB block, AV destination devices may request AV streams from AV source devices, which may be transported across the AVB network within specified latency target values as determined from Quality of Service (QoS) descriptors associated with delivery of an AV stream.

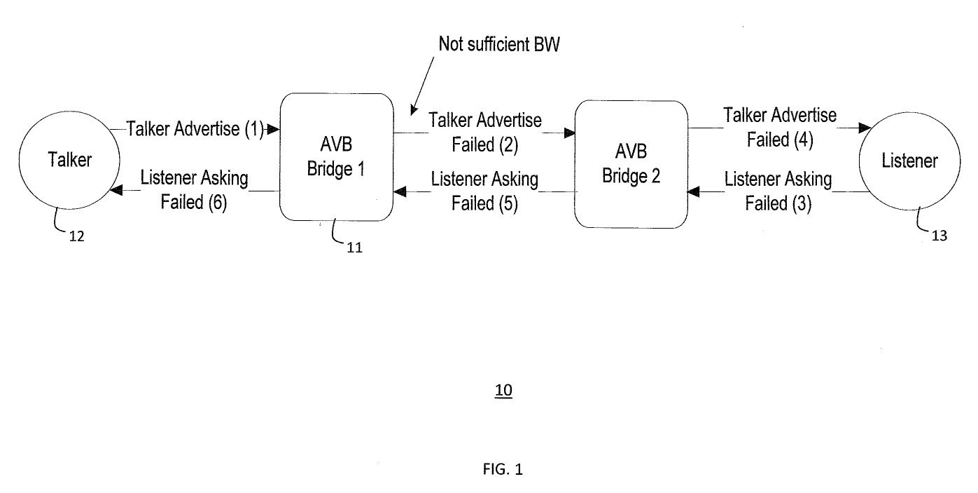

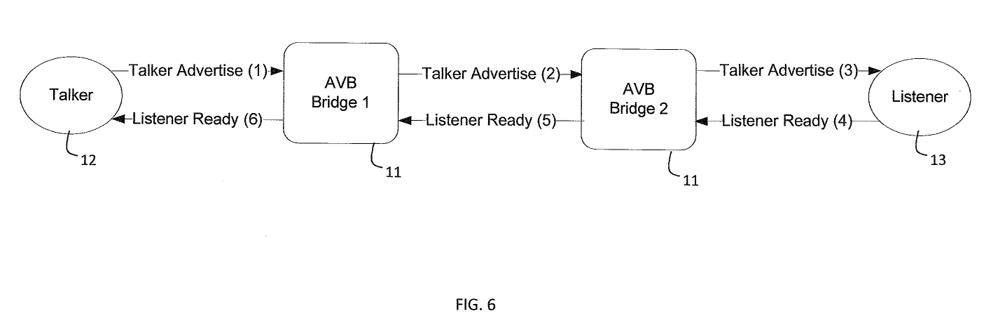

FIG. 1 shows an example AVB network 10 comprising a bridged network of devices comprises AV devices including one or more bridge devices 11, a Talker device 12 and a Listener device 13, wherein the bridge devices connect a Talker device 12 and a Listener device 13 via communication links forming at least one path. FIG. 1 illustrates Bandwidth allocation failure, wherein a bridge 11 (i.e., AVB Bridge 1) does not have sufficient bandwidth for streaming between a Talker device 11 (i.e., Talker) and a Listener device 13 (i.e., Listener). This results in the Talker 12 generating a Talker Advertisement Failed indication. According to IEEE 802.1Qat, a Talker will receive either Listener Ready Failed or Listener Asking Failed. However, the Talker will not know the amount of the actual available bandwidth along a network path from the Talker to the Listener. FIG. 6 illustrates a successful bandwidth allocation process, wherein both AVB Bridge 1 and AVB Bridge 2 have sufficient bandwidth, such that the Talker Advertisements are forwarded. The Listener 13 generates a Listener Ready message which upon arriving at the Talker 12 indicates that AV streaming between the Talker 12 and the Listener 13 can be initiated.

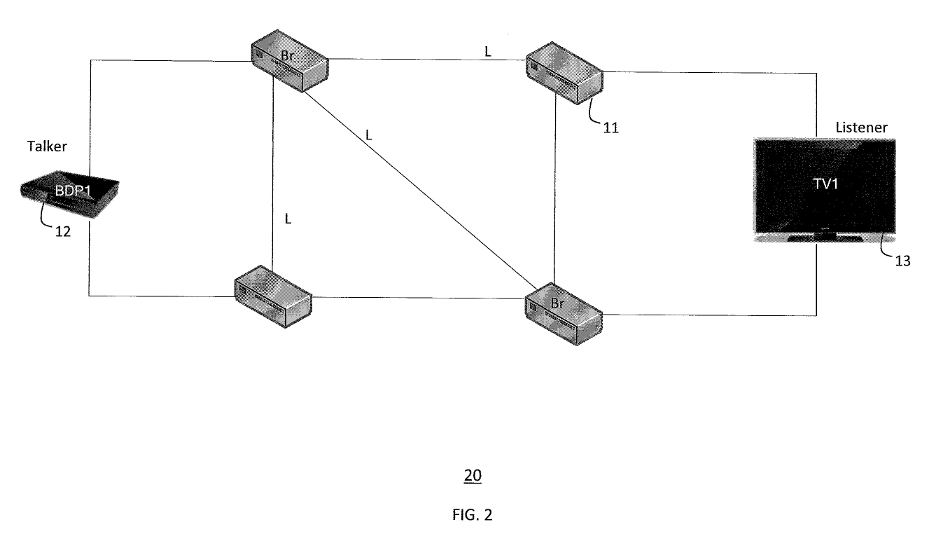

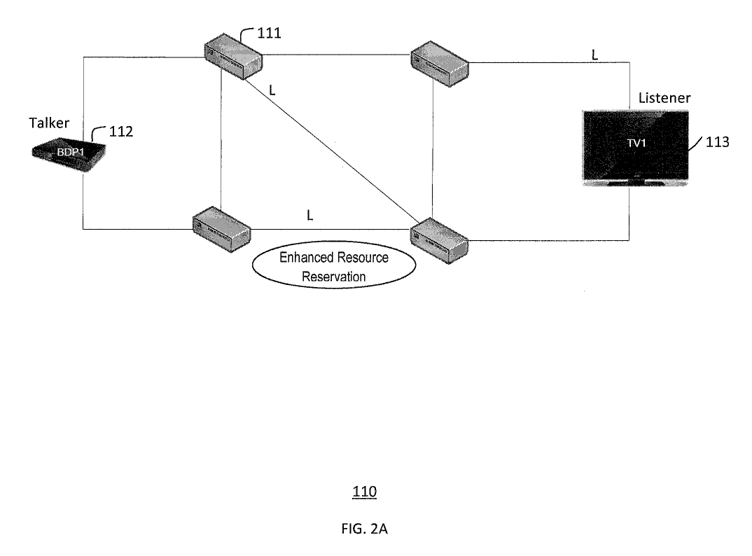

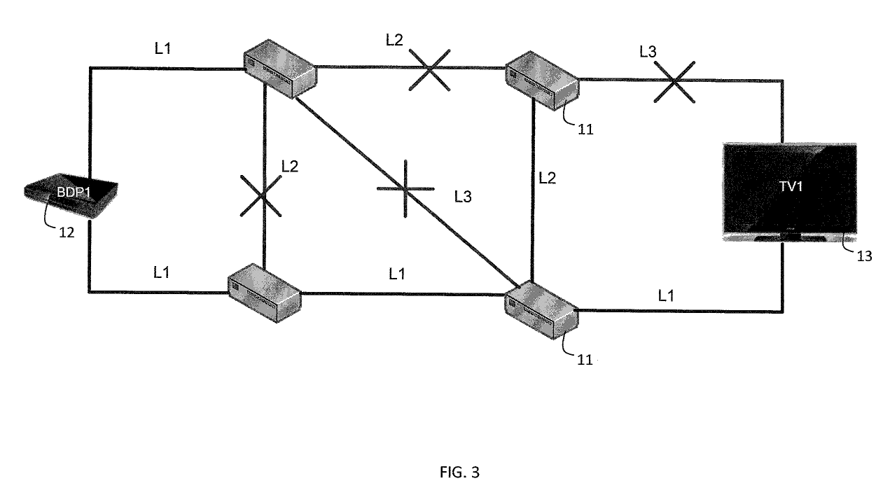

FIG. 2 illustrates an example AV network 20, wherein a Talker 12 (i.e., Talker BDP1) and a Listener 13 (i.e., Listener TV1) are connected over a bridged network using one or more bridges 11 (i.e., Br) via links L. FIG. 3 shows a configuration after STP initialization in the AV network of FIG. 2. Once STP finishes its initialization, a few ports in the network are blocked (shown by “x”) in order to avoid cycles or loops.

IEEE 802.1Qat SRP allocates bandwidth on links that belong to the STP, wherein there is one unique path from the Talker to the Listener. In case such links are saturated or fully loaded (i.e., bandwidth allocation reaches the supported bandwidth limit), no further AV streams can be allocated on those links. However, there may be alternative paths from the Talker to the Listener but those cannot be used by the SRP. This results in streaming failure at the application layer. In addition, there is no active path redundancy provided in the AV network. Whenever there is a port failure, the STP triggers to causes unblocking some of the blocked ports. This forces the IEEE 802.1Qat SRP to reissue Talker and Listener advertisements. Eventually, the bandwidth is allocated on the new set of links that are part of the STP. However, the impact of such actions is temporary failure of AV streaming, resulting in catastrophic failure for high quality AV streaming in Next Generation Interface such as Next Generation HDMI Interface.

According to an embodiment of the invention, in an AVB network of bridged AV devices comprising a Talker device, a Listener device and one or more bridge devices, an AV device is provided with additional information (such as available network bandwidth) that facilitates selection of an appropriate level of compression or resolution that can fit within the available bandwidth. Knowing the available bandwidth allows an AV device, such as a Talker device, to select the appropriate bandwidth allocation in a next allocation attempt. In certain cases the bandwidth allocation occurs in conjunction with application layers, wherein the link layer bandwidth is mapped to the selected AV format for streaming.

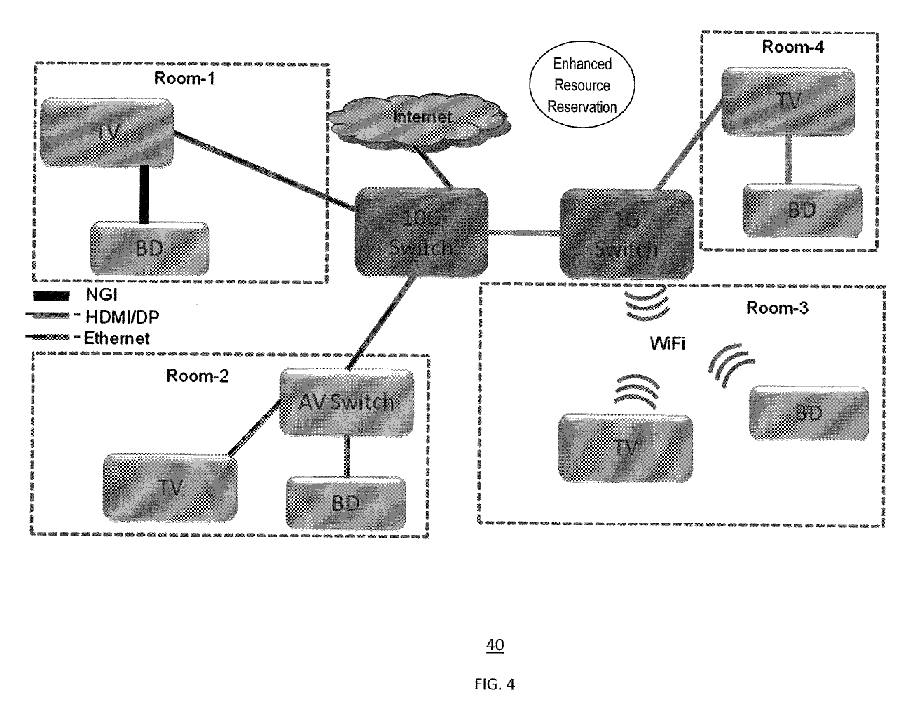

FIG. 4 shows an example network 40, such as Next Generation Interface (NGI) network in which embodiments of the invention may be implemented. The network 40 comprises bridged network using one or more bridges connecting Talker devices and Listener devices via communication links. An NGI implementation may comprise an AVB network including AVB end points optionally supporting ultra high speed NGI that in one example supports at least 20 Gbps. In such a network, a payload may comprise AV content that may be native video or AV content that is formatted by a display interface process such as HDMI, Display Port or DVI. A variety of video formats are expected to be supported, ranging from 3D, 4KUD, HD, lossless and visually lossless.

According to conventional IEEE 802.1Qat, a Talker node generates a Talker Advertise declaration message to make an announcement to other nodes in the LAN and update its Multiple SRP (MSRP) table. A Talker Advertise message includes the MAC address of the Talker, declaration type and required bandwidth, etc. For example, after a bridge port 0 receives the Talker Advertise message, MSRP registers it in its MSRP table and sends to other ports in the bridge. A bridge port 1 which receives the Talker Advertise message by bridge port 0, registers that message at its MSRP table and compares the requirement bandwidth of the message with its available bandwidth. If the available bandwidth is larger than the required bandwidth, the message is forwarded to the other node. Otherwise, the message is changed to Talker Failed message and forwarded. After the Talker Advertise message arrives at a Listener, the Listener generates a Listener Ready message and sends it to the Talker if the Listener desired to receive service from the Talker.

A Listener Ready message has only the StreamID of the Talker, wherein the StreamID includes the MAC address of the Talker and an integer number. For example, a bridge port n which receives a Listener Ready message reserves the required bandwidth, if port n has sufficient available bandwidth. When bandwidth reservation is successful at a port, the Listener Ready message is forwarded to the Talker by MSRP attribute propagation. The Talker receiving the Listener Ready message compares its MSRP table with the StreamID in the Ready message. If the Listener Ready message is associated with a stream that the Talker can supply, the Talker can start the transmission for the stream immediately. The Talker and Listener advertisements can be summarized as below in Table 1:

TABLE 1
Talker and Listener advertisements

| Message | | Description |
|---|---|---|
| Talker | Advertise | Advertise for stream that has not yet encountered |
| | | any bandwidth or other network constraints along |
| | | the network path from the Talker |
| | Failed | Advertisement for a stream that cannot be started or |
| | | not available to the Listener because of bandwidth |
| | | constraints somewhere along the path from the |
| | | Talker |
| Listener | Ready | One or more Listeners are requesting attachment |
| | | to the stream. There is sufficient bandwidth and |
| | | resources available along the path(s) back to the |
| | | Talker for all Listeners to receive the stream |
| | Asking | One or more Listeners are requesting attachment to |
| | Failed | the stream. None of those Listeners are able to |
| | | receive the stream because of network bandwidth or |
| | | resource allocation problems |
| | Ready | Two or more Listeners are requesting attachment to |
| | Failed | the stream. At least one of those Listeners has |
| | | sufficient bandwidth and resources along the path to |
| | | receive the stream, but one or more other Listeners |
| | | are unable to receive the stream because of network |
| | | bandwidth or resource allocation problems |

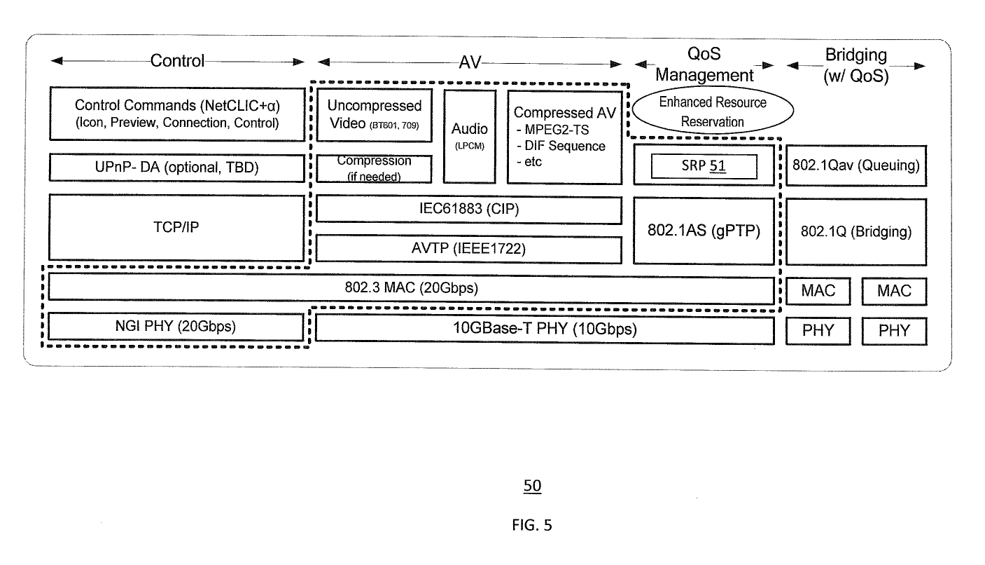

FIG. 5 shows an NGI protocol stack 50 for an AVB network based on IEEE 802.1AVB, 1722 and IEC61883. A QoS Management function in the stack 50 includes an enhanced IEEE 802.1Qat SRP module 51 implementing an enhanced bandwidth reservation mechanism, according to an embodiment of the invention. A function of the SRP module 51 is to enable end-to-end isochronous resource reservation, as described herein. SRP defines the concept of streams at Layer-2 (L2) of the OSI model.

Embodiments of the invention provide an enhanced resource reservation scheme for IEEE 802.1Qat, wherein the enhanced resource reservation scheme includes modification and additions to conventional IEEE 802.1Qat SRP to include support for improved error reporting and quickly overcoming changes in AV network bandwidth. Since the enhanced IEEE 802.Qat can quickly adapt to network changes, the AV quality is not impacted and hence, leads to better user experience.

According to an embodiment of the invention, a bridge with insufficient bandwidth sends a Talker Advertise Failed message with a modified traffic specification to indicate the available bandwidth from the Talker to the Listener. The Talker Advertise Failed message is propagated to the Talker. Talker advertisements are forwarded on all ports by the Talker, including on blocked ports. For one Talker and one stream, multiple Talker Advertise messages are received by the Listener over multiple paths.

According to an embodiment of the invention, Talker Advertisements are enhanced to include additional attributes to capture more details of an end-to-end path from the Talker to the Listener. A Listener selects an optimum path based on various parameters (e.g., a path with highest minimum available bandwidth for the stream). A Listener can select a back path as well. As such, SRP quickly overcomes network changes to maintain quality of service. In an application of an embodiment of the invention, a Next Generation HDMI Interface standard is interoperable with IEEE 802.1AVB.

Conventional IEEE 802.1Qat provides a Talker Failed mechanism wherein a Talker Advertise Failed message includes a Traffic Specification (TSpec) component associated with a stream. The TSpec component comprises 32-bits including the following two elements:
1. MaxFrameSize: A 16-bit unsigned MaxFrameSize component used to allocate resources and adjust queue selection parameters in order to supply the quality of service requested by an MSRP Talker Declaration. This component represents the maximum frame size that the Talker will produce, excluding any overhead for media specific framing (e.g., preamble, IEEE 802.3 header, Priority/VID tag, CRC, interframe gap).
2. MaxInterValFrame: A 16-bit unsigned MaxIntervalFrames component used to allocate resources and adjust queue selection parameters in order to supply the quality of service requested by an MSRP Talker Declaration. This component represents the maximum number of frames that the Talker may transmit in one “class measurement interval”.

In one embodiment the present invention provides a Modified Talker Failed mechanism for IEEE 802.1Qat, wherein a Talker Advertise Failed message includes a TSpec component associated with a stream, such that the TSpec component indicates the available bandwidth.

According to an embodiment of the invention, a bridge with insufficient bandwidth sends a Talker Advertise Failed message having a modified Tspec component that indicates the available bandwidth. According to an embodiment of the invention, instead of indicating the available bandwidth in terms of MaxFrameSize and MaxlnterValFrame, the actual bandwidth is presented using the 32 bits. The indication of available bandwidth does not require any modification to SRP messages.

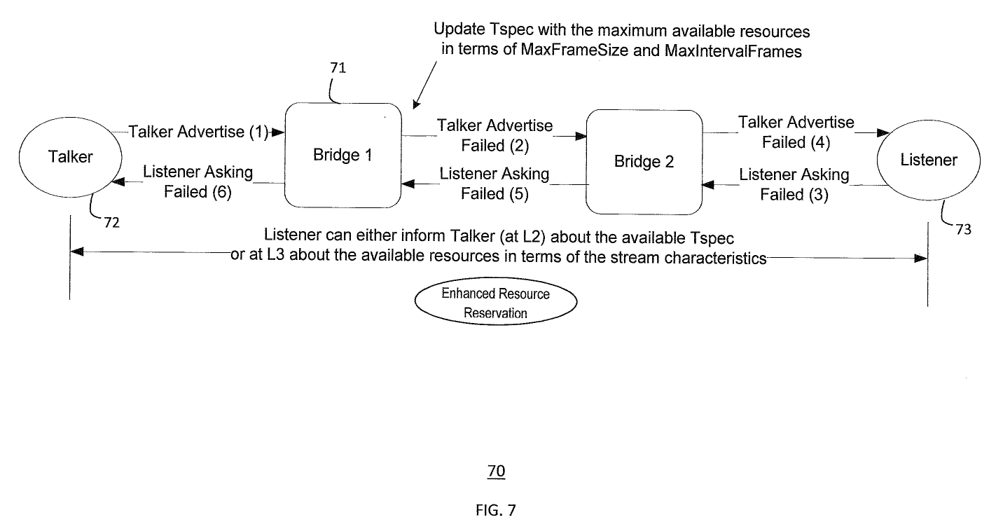

In one embodiment, the present invention provides an enhanced bandwidth reservation mechanism for IEEE 802.1Qat, including Failed Bandwidth indicated via a Talker Advertise Failed message. FIG. 7 illustrates an AV network 70, according to an embodiment of the invention, wherein Failed Bridge indication modifies Talker Advertise Failed indication. A bridge 71 (i.e., Bridge 1) has insufficient bandwidth and generates a Talker Advertise Failed message with indicates the available bandwidth. In case the available bandwidth at Bridge 2 is smaller than Bridge 1, then Bridge 2 further updates the Tspec field of the Talker Advertise Failed. Eventually, the Listener 73 receives the Talker Advertise Failed message indicating the minimum bandwidth available on the path from the Talker 72 to the Listener 73.

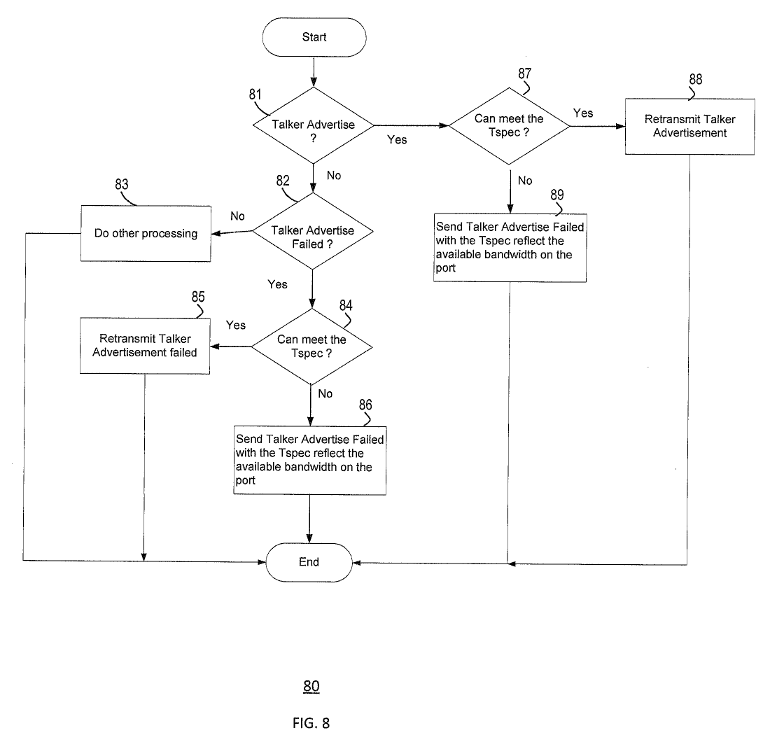

FIG. 8 illustrates a flowchart of a process 80 for an embodiment of the enhanced bandwidth reservation with a modified SRP, according to an embodiment of the invention. Process block 81 comprises checking for a Talker Advertise message for streaming between a Talker and a Listener. If a Talker Advertise message is not detected, then process block 82 comprises checking for a Talker Advertise Failed message. If a Talker Advertise Failed message is not detected then process block 83 performs other processing and the process ends. If a Talker Advertise Failed message is detected, process block 84 comprises determining if resource requirements specified in the TSpec can be met. If the resource requirements can be met, then process block 85 comprises retransmitting a Talker Advertisement Failed message, and the process ends. If the resource requirements cannot be met the process block 86 comprises sending Talker Advertise Failed with a TSpec reflecting the available bandwidth at the involved port, and the process ends.

If in process block 81 a Talker Advertise message is detected, then process block 87 checks if resource requirements specified in the TSpec can be met. If the resource requirements can be met, then process block 88 retransmits Talker Advertisement message, and the process ends. If the resource requirements cannot be met then process block 89 comprises sending a Talker Advertise Failed with TSpec reflecting the available bandwidth on the port involved, and the process ends.

In one embodiment the present invention provides a reservation mechanism including Failed Bandwidth indicated to the Talker via Listener Messages. The Listener 73 informs the Talker 72 (at Layer-2 in the protocol stack) about the available bandwidth. In an alternative embodiment, the Listener 73 informs a centralized device (or directly informs the Talker at Layer-3) indicating the available bandwidth in terms of the video format that can be supported at the Listener 73. There is no need to modify Talker Advertise Failed indication. However, when informing the Talker 72 at Layer-2 about available bandwidth, a new control message is used or the Listener message is modified. In one embodiment of the invention, the Listener Ready Failed or Listener Asking Failed are modified to include the Available Bandwidth on the link from the Talker 72 to the Listener 73. If Bridge 1 generates Listener Asking Failed then it will update the available bandwidth in TSpec. The TSpec field is updated with the maximum available resources in terms of MaxFrameSize and MaxIntervalFrames. However, if both Bridge 1 and Bridge 2 have insufficient bandwidth, then minimum bandwidth between Bridge 1 and Bridge is reflected in the Listener message to the Talker 72.

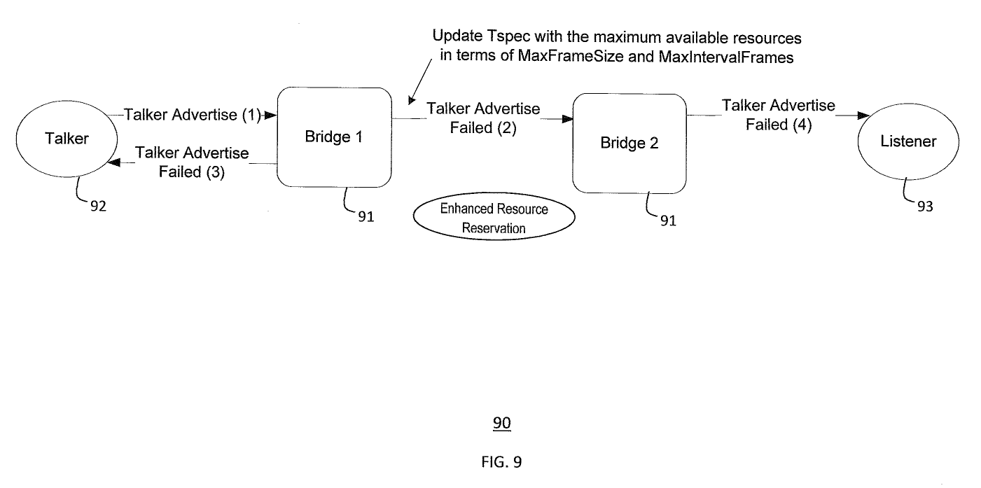

Referring to the AV network 90 in FIG. 9, in one embodiment the present invention provides an enhanced reservation mechanism including Failed Bandwidth indicated to a Talker 92 via Talker Advertise Failed Message. Normally Talker Advertise Failed messages are not transmitted back to the Talker. In one implementation of the invention, a modified Talker Advertise Failed Message includes vital information about the available bandwidth from the Talker 92 to the Listener 93. The Talker Advertise Failed message is sent back to the Talker 92, as illustrated by example in FIG. 9. Specifically, FIG. 9 illustrates a case wherein a first bridge 91 (i.e., Bridge 1) sends back a Talker Advertise Failed message to the Talker 92. In case a second bridge 91 (i.e., Bridge 2) supports even a lower bandwidth than Bridge 1 on the path to the Listener 93, then Bridge 2 generates another Talker Advertise Failed message back to the Talker 92.

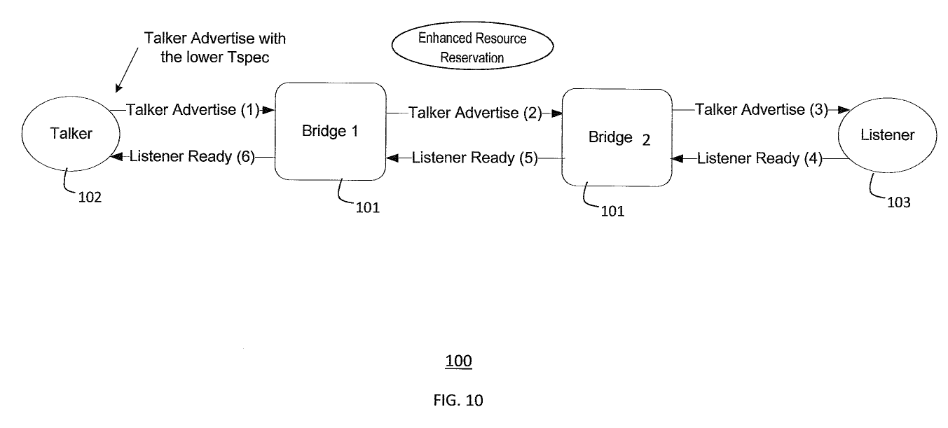

Referring to the AV network 100 in FIG. 10 according to an embodiment the present invention, an example application involves employing an enhanced resource reservation schemes according to embodiments of the invention, described above, whereby a Talker 102 has knowledge of the available bandwidth on the path from the Talker 102 to a Listener 103. As illustrated by example in FIG. 10, the Talker 102 re-issues another Talker Advertise with a lower Tspec that fits within the minimum end-to-end bandwidth on the path from the Talker 102 to the Listener 103 via the bridges 101. Once the Talker 102 receives a Listener ready message corresponding to the Talker advertise message, the AV streaming between the Talker 102 and the Listener 103 is started.

The IEEE 802.1 Qat Talker Advertise conventionally includes the following fields:

StreamID
DataFrameParameter

Destination Address
Vlan_identifier

Tspec

MaxFrameSize
MaxIntervalFrame

PriorityAndRank

Data Frame priority
Rank

AccumulatedLatency

According to an embodiment of the invention, providing an enhanced resource reservation scheme, additional network attributes (e.g., in fields) are provided in the Talker Advertise message to capture extensive characteristics of a path including communication links, between a Talker and a Listener. An example of such additional network attributes (i.e., path metrics as new attributes) including link attributes for Talker Advertise messages, including:

Downstream Bandwidth (BW)
Upstream BW
Downstream available BW
Upstream available BW
PER
Link type
Latency
Hopcount
Currently admitted StreamIDs

FIG. 2A illustrates a switched AVB network 110 of AV devices (e.g., AVB devices). Each AV device includes one or more I/O ports for connecting the AV device to another AV device via a communication link (which may includes one or more communication lanes). The AV devices in the network 110 comprise a source AV device, and a destination AV device connected by intermediate AV devices (switches/bridges) via communication links, according to an embodiment of the invention.

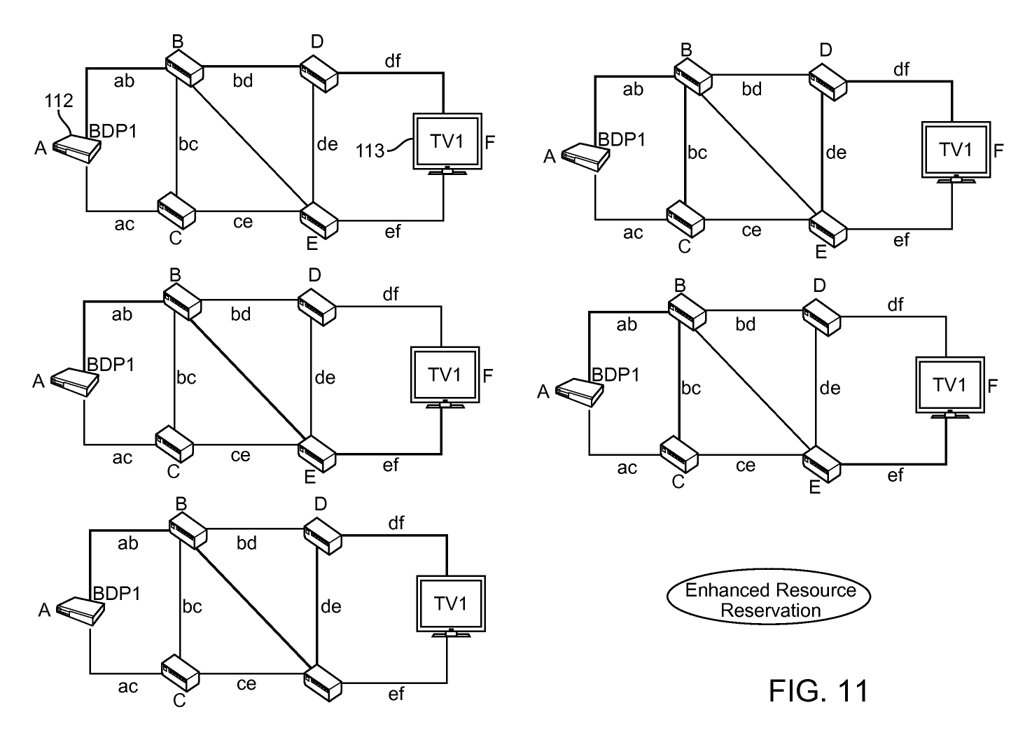

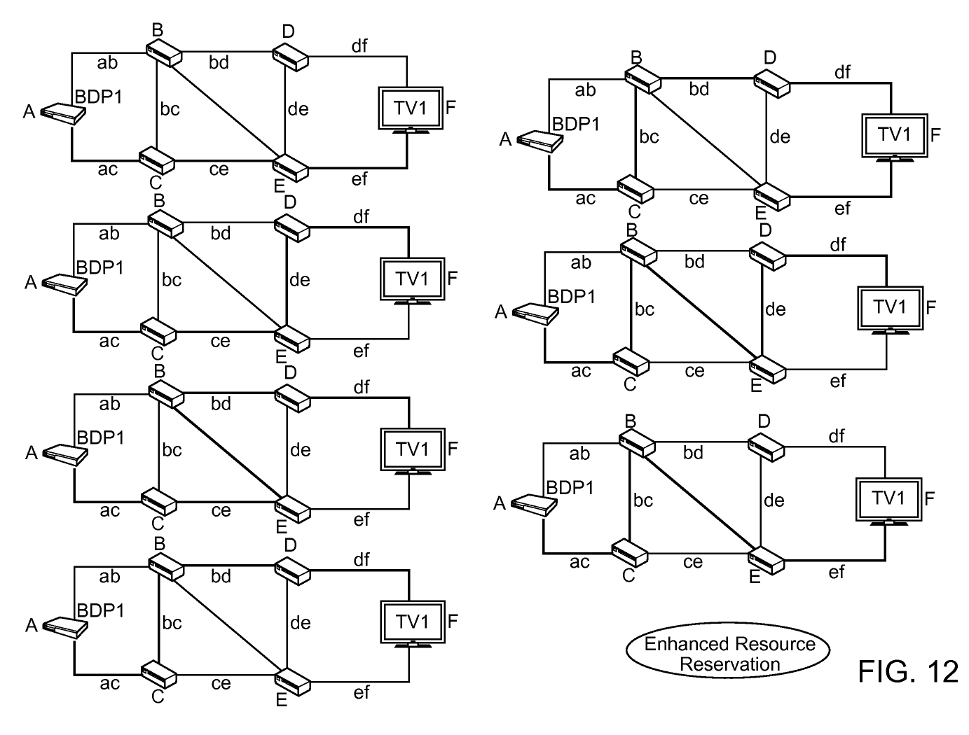

The AV source device comprises a Talker 112 (e.g., BDP-1) and the AV destination device comprises a Listener 113 (e.g., TV1). The network includes multiple alternative paths between the Talker 112 and the Listener 113 via links and bridges 111. FIG. 11 shows alternative paths between nodes 112 and 113 of the network 110, originated on link ab as indicated in bolded links. FIG. 12 shows alternative paths between nodes 112 and 113 of the network 110, originated on link ac as indicated in bolded links. Each link represents a network hop. The Listener 113 can select an optimum path based on a certain path metrics (e.g., available bandwidth (BW) on a device port) once the Listener 113 knows all the available path choices and characteristics of those paths, according to embodiments of the invention.

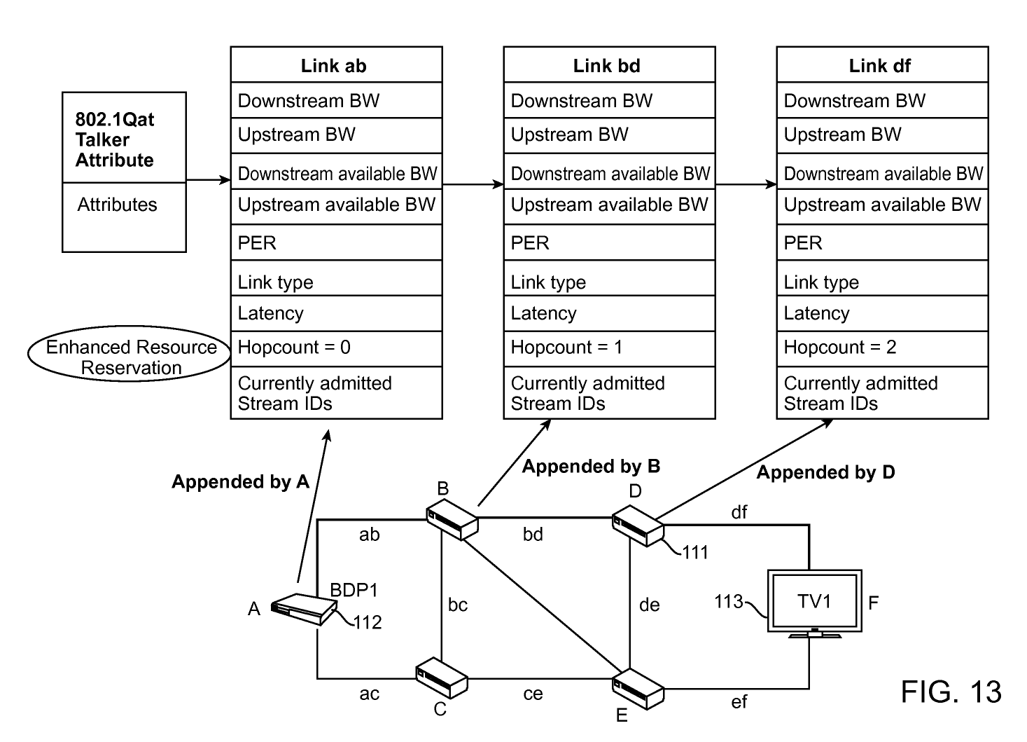

In the network shown in FIG. 2A, at each port the Talker Advertise is processed by appending the additional attributes to the Talker Advertise message. FIG. 13 illustrates a message flow for the network in FIG. 2A and processing of Talker Advertisement messages, according to an embodiment of the invention. When the Talker Advertise message flows on the links ab→bd→df, first the Talker 112 (BDP-1) appends said additional network resource attributes to link ab. Next, the Bridge B appends the additional network resource attributes to link bd followed by bridge D appending additional network resource attributes for link df. The Listener 113 now has a complete view of one end-to-end path from the Talker 112 to the Listener 113.

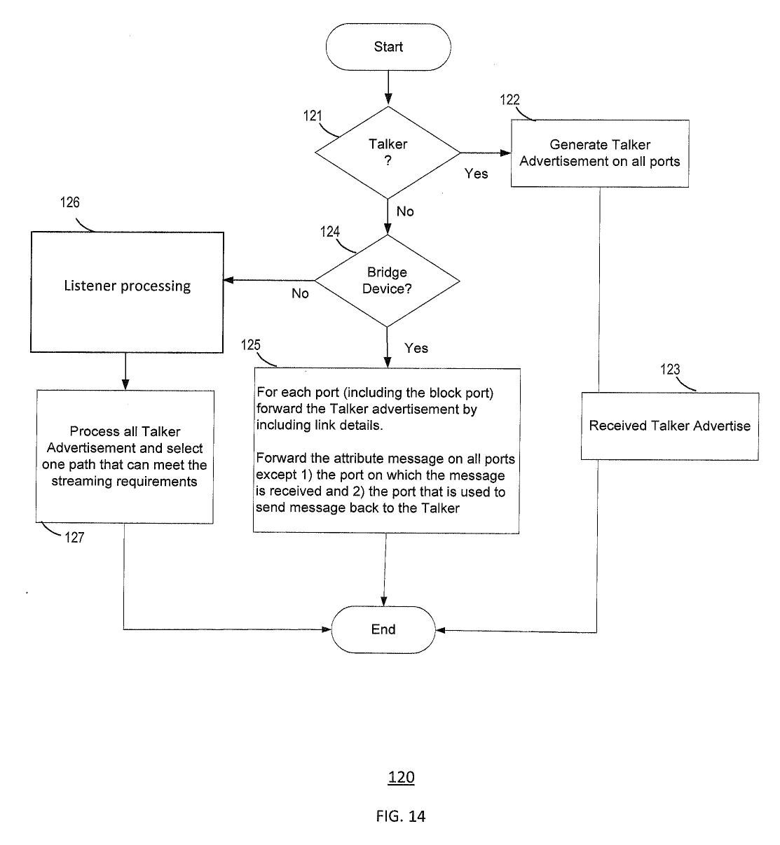

FIG. 14 shows a flowchart of a process 120 for processing a Talker Advertisement message including additional network resource attributes, according to an embodiment of the invention. In process block 121 if a Talker device is processing a Talker Advertisement message, in process block 122 a Talker Advertisement message is generated and sent on all Talker ports, wherein in process block 123 Talker Advertisement messages are received, ending the process. In process block 121, if a Talker device is not involved, then in process block 124 if a bridge device is processing, then in process block 125 for each port (including a blocked port), the Talker Advertisement message is forwarded by including said additional link attributes. Further, the message with the link attributes is forwarded on all ports except a port on which the message is received, and a port that is used to send a message back to the Talker. If in process block 124 a bridge device is not processing, then based on process block 126 detecting that a Listener device processing, in process block 127 all Talker Advertisement messages are processed and based on the link information a path (comprising links) is selected that can meet the streaming requirements between the Talker and the Listener.

According to an embodiment of the invention, enhancements to resource allocation (i.e., resource reservation) in the Talker Advertise protocol for enhancing the conventional IEEE 802.1Qat include:
1. For one Talker and one stream, multiple Talker Advertise messages are received at the Listener over multiple paths.
2. Talker advertise messages are forwarded on all ports by the Talker.
3. Talker advertise messages are forwarded on blocked ports as well.
4. Talker advertise messages include said additional link attributes to capture more details of an end-to-end path from the Talker to the Listener.

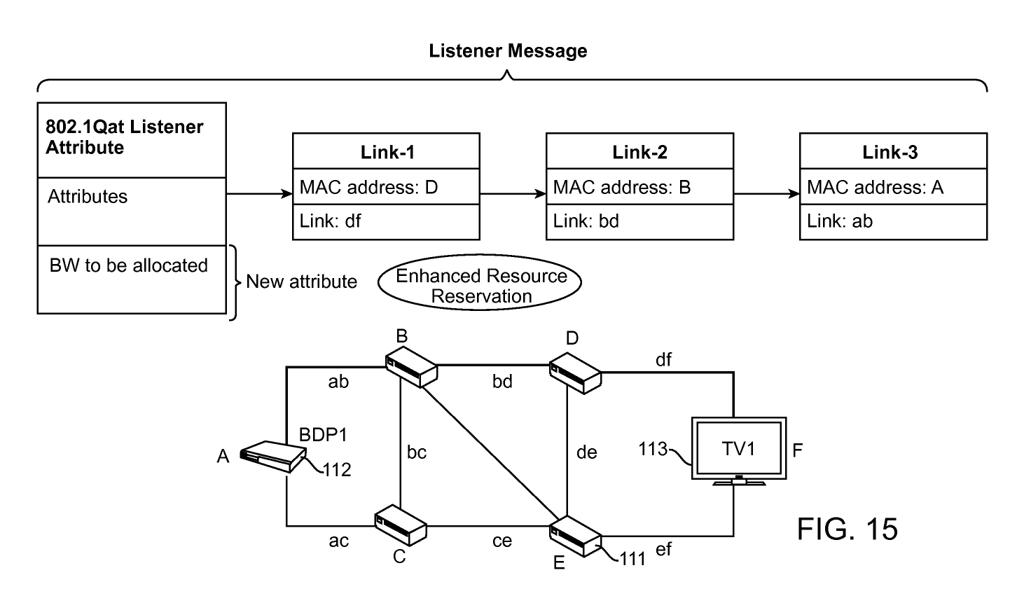

FIG. 15 illustrates an example case wherein the Listener 112 selects df→bd→ab path. The Listener 113 appends path metrics fields in the Listener Attribute. Only those links which are included in the Listener message need to allocate the bandwidth. The Listener 113 processes all received Talker Advertise messages from a single Talker 112 for a particular stream. The Listener 113 selects a particular path based on the path metrics (new attributes) suitable to meet the AV streaming. The Listener 113 indicates this information to the Talker 112 over the selected path so that the intermediate nodes (e.g., one or more bridges 111) allocate and reserve the resources for the particular ensuing stream. The Listener message includes a new attribute about bandwidth to be allocated. The Listener message also includes a list of links selected by it.

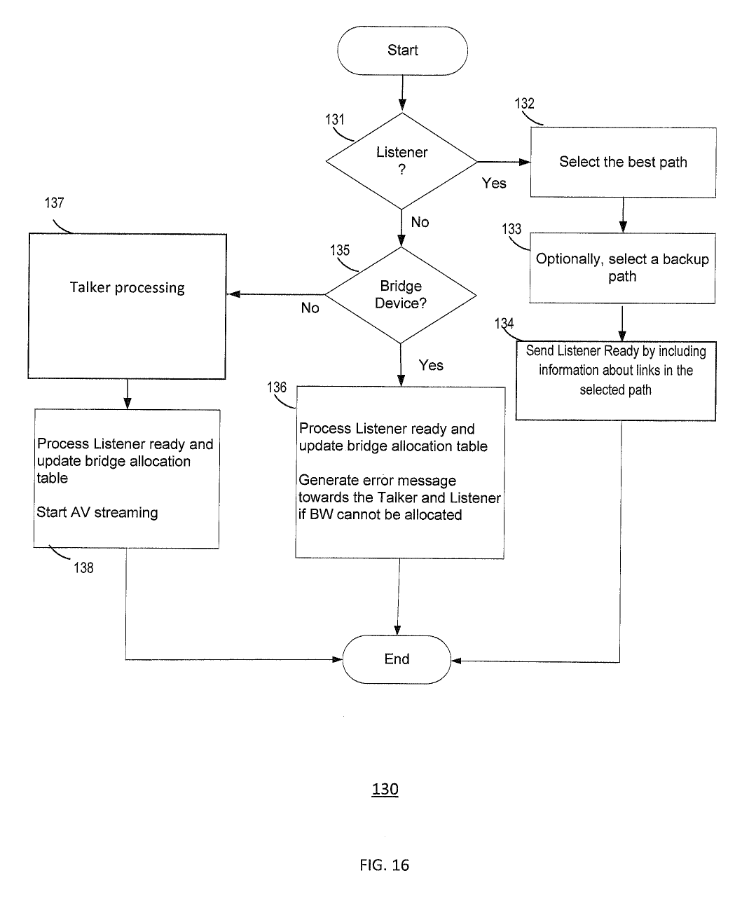

According to an embodiment of the invention, enhancements over conventional Listener message in IEEE 802.1Qat, include: a Listener selecting an optimum path based on various link parameters, and the Listener can select a back path to the Talker as well. FIG. 16 shows a flowchart of a process 130 for Listener message processing, according to an embodiment of the invention.

In process block 131 if a Listener device is processing, then in process block 132 a best path from to the Talker to the Listener is selected based on the link attribute information to meet streaming requirements. In process block 133, optionally a path back from the Listener to the Talker is also selected based on the link attributes. In process block 134 a Listener Ready message is sent which includes information about the links in the selected path(s), and end process.

If in process block 131 a Listener is not processing, then in process block 135 if a bridge device is processing, then in process block 136 a Listener Ready message is processed wherein bridge allocation table is updated and an error message is generated to the Talker and the Listener if sufficient bandwidth (BW) required for streaming cannot be allocated, and the process ends.

In process block 135 if a bridge device is not processing, then based on process block 137 detecting that a Talker device is processing, in process block 138 Listener Ready messages are processed and bridge allocation table is updated, wherein AV streaming between Talker and Listener is started.

As noted, conventionally IEEE 802.1Qat SRP provides limited resilience against network failures. A port failure event is triggered by the STP reinitializing and changing ports from blocked to unblocked and vice-versa. Once STP is stabilized, the SRP needs to re-run and allocate bandwidth on newly selected ports by the STP. This can cause a long outage to AV streaming on a path.

Embodiments of the invention allow selecting a backup (yet non-active) path such that whenever a Listener detects a path loss event, the Listener can trigger switchover from a primary AV streaming path to the backup AV streaming path. The Listener can trigger such an event based on one of the many conditions including Packet loss exceeds the threshold, PSNR is below the acceptable level, Excess delay and Jitter, etc. According to an embodiment of the invention, an enhancement to conventional IEEE 802.1Qat comprises decoupling SRP from STP (after failure, no need to rerun the SRP). Further, a backup path is already established that can be selected instantaneously, whereby effects of AV streaming outage are reduced.

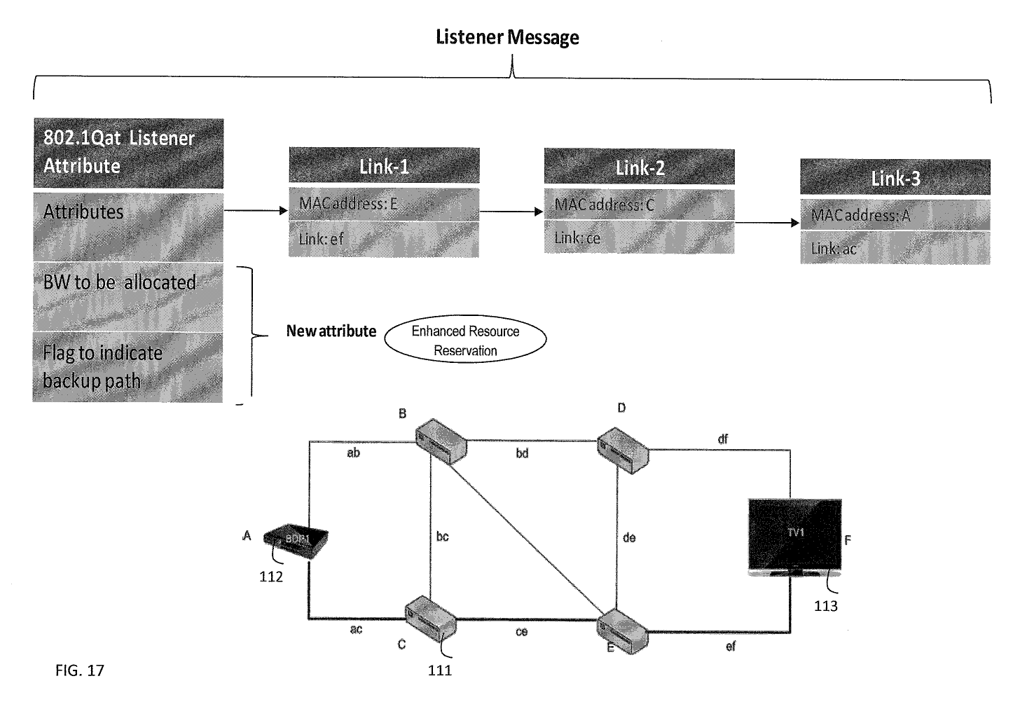

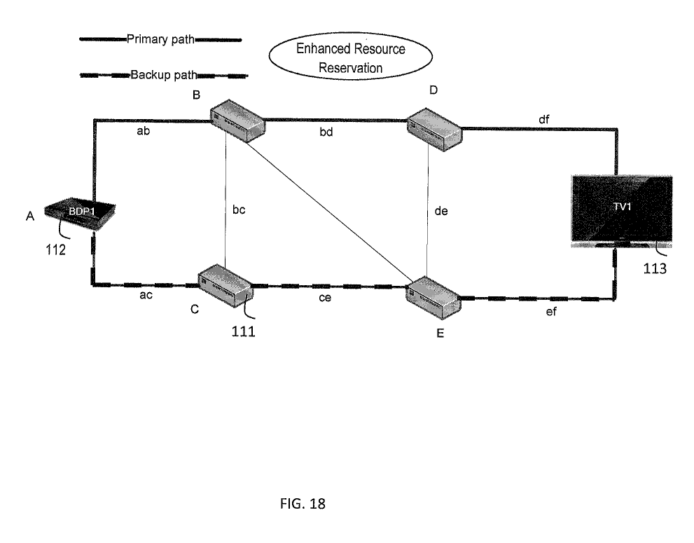

FIG. 17 illustrates an AV network implementation according to an embodiment of the invention, wherein a Listener message includes an additional field to indicate if it is a backup path or not. As illustrated by example in FIG. 18, a backup path (shown in broken lines) is selected over links ac→ce→ef, according to an embodiment of the invention. In the event of a failure, the Listener 113 signals the Talker 112 to start streaming over the backup path (the primary path and backup paths are shown in FIG. 18).

According to an embodiment of the invention, an AV device may comprise an Application Layer (Layer 7) including processes that use the network, a Transport or TCP Layer (Layer 4) including processes that provide end-to-end data delivery, an IP Layer or Network/Internet Layer (Layer 3) including processes handling routing of data, a Link Layer (Layer 2) and a Physical Layer (Layer 1) for accessing physical communication medium. These layers are similar to TCP/IP layers which can be loosely mapped to the Open System Architecture (OSI). The Link Layer includes a MAC Layer and the Physical Layer includes a PHY Layer, configured for communication over an AV network.

As is known to those skilled in the art, the aforementioned example architectures described above can be implemented in many ways, such as program instructions for execution by a processor, as software modules, microcode, as computer program product on computer readable media, as logic circuits, as application specific integrated circuits, as firmware, as consumer electronic devices, etc., in wireless devices, in wireless transmitters/receivers, in wireless networks, etc. The disclosed embodiments can take the form of an entirely hardware embodiment, an entirely software embodiment or an embodiment containing both hardware and software elements.

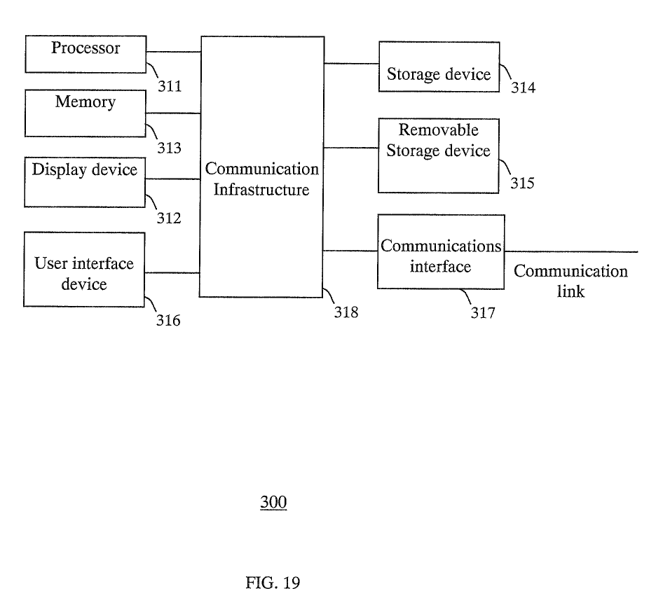

FIG. 19 is a high level block diagram showing an information processing system comprising a computer system 300 useful for implementing an embodiment of the present invention. The computer system 300 includes one or more processors 311, and can further include an electronic display device 312 (for displaying graphics, text, and other data), a main memory 313 (e.g., random access memory (RAM)), storage device 314 (e.g., hard disk drive), removable storage device 315 (e.g., removable storage drive, removable memory module, a magnetic tape drive, optical disk drive, computer readable medium having stored therein computer software and/or data), user interface device 316 (e.g., keyboard, touch screen, keypad, pointing device), and a communication interface 317 (e.g., modem, a network interface (such as an Ethernet card), a communications port, or a PCMCIA slot and card). The communication interface 317 allows software and data to be transferred between the computer system and external devices. The system 300 further includes a communications infrastructure 318 (e.g., a communications bus, cross-over bar, or network) to which the aforementioned devices/modules 311 through 317 are connected.

Information transferred via communications interface 317 may be in the form of signals such as electronic, electromagnetic, optical, or other signals capable of being received by communications interface 317, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method of communication in a bridged network, comprising:
a Talker device sending a Stream Reservation Protocol (SRP) Talker Advertise message for streaming data to a Listener device;
receiving the Talker Advertise message and checking bandwidth availability on an output port thereof for the streaming; and
in case of insufficient communication bandwidth, sending a failure message that includes information about available bandwidth from the Talker device to the Listener device.

2. The method of claim 1, wherein:
receiving the Talker Advertise message comprises an intermediate bridge device receiving the Talker Advertise message, checking bandwidth availability on an output port thereof for the streaming, and sending a Talker Advertise Failed message with a modified traffic specification to indicate said information about available bandwidth.

3. The method of claim 2, further comprising the Listener device receiving said Talker Advertise Failed message indicating the minimum available bandwidth from the Talker device to the Listener device.

4. The method of claim 3, further comprising selecting a path from the Talker device to the Listener device based on said information about available bandwidth.

5. The method of claim 2 further comprising:
a bridge receiving said Talker Advertise Failed message and forwarding the message out towards the Listener device; and
the Listener device responding with a Listener Asking Failed message that is forwarded back towards the Talker device.

6. The method of claim 3, further comprising:
the Listener device informing the Talker device at a Layer-2 about said available bandwidth.

7. The method of claim 3, further comprising:
the Listener device informing the Talker device at a Layer-3 about said available bandwidth.

8. The method of claim 3, further comprising:
the Listener device informing a centralized device about said available bandwidth in terms of a video format that can be supported at the Listener device.

9. The method of claim 5, further comprising:
sending the Talker Advertise Failed message back to the Talker device, informing the Talker device about said available bandwidth on a path from the Talker device to the Listener device, wherein the Talker device is informed of the minimum end-to-end available bandwidth on a path from the Talker device to the Listener device.

10. The method of claim 9, further comprising:
the Talker device re-issuing another Talker Advertise with a traffic specification based on the minimum end-to-end bandwidth on the path from the Talker device to the Listener device; and
the Talker device receiving said Listener Ready message corresponding to the Talker Advertise Message, and starting data streaming to the Listener device.

11. The method of claim 1, wherein the bridged network comprises an Audio Video Bridging (AVB) network of AV devices.

12. The method of claim 2, wherein:
the network comprises multiple bridge devices; and
adjusting the available bandwidth (BW) along the path of Talker to Listener with multiple bridges, including each intermediate bridge device receiving the Talker Advertise message, checking bandwidth availability on an output port thereof for the streaming, and updating modified traffic specification to indicate said information about available bandwidth.

13. The method of claim 2, further comprising:
a bridge responding with a Talker Advertise Failed message to the Talker device, without waiting for a response from the Listener device.

14. A method of communication in a bridged network, comprising:
a Talker device sending a Stream Reservation Protocol (SRP)Talker Advertise message for streaming data to a Listener device, the Talker Advertise message including communication path information from the Talker device to the Listener device;
selecting a communication path from the Talker device to the Listener device based on said path metrics, for streaming data between the Talker device and the Listener device.

15. The method of claim 14, wherein Talker Advertise message includes information about available bandwidth comprising:
Downstream BW (Bandwidth),
Upstream BW,
Downstream available BW,
Upstream available BW,
PER,
Link type,
Latency,
Hopcount,
Currently admitted Stream IDs.

16. The method of claim 14, further comprising:
at each device port on a communication path between the Talker device and the Listener device processing the Talker Advertise message by appending additional network bandwidth information to the Talker Advertise message.

17. The method of claim 16, further comprising:
the Listener device receiving the Talker Advertise message indicating end-to-end available bandwidth on a communication path from the Talker device to the Listener device.

18. The method of claim 16, further comprising:
the Listener device receiving multiple Talker Advertise messages, each Talker Advertise message indicating end-to-end available bandwidth on a communication path from the Talker device to the Listener device.

19. The method of claim 18, further comprising:
the Listener device utilizing said Talker Advertise messages from said Talker device for a particular stream, to select a particular path based on the path metrics suitable to meet the streaming.

20. The method of claim 19, further comprising:
the Listener device indicating said selection to the Talker device wherein intermediate nodes allocate and reserve the resources for the particular ensuing stream.

21. The method of claim 20, further comprising:
the Listener device sending a message to the Talker device about bandwidth to be allocated, the listener message including a list of links in the selected communication path.

22. The method of claim 18, further comprising the Listener device selecting a backup communication path for said stream.

23. The method of claim 14, wherein the bridged network comprises an Audio Video Bridging (AVB) network of audio video (AV) devices.

24. A bridged communication system, comprising:
a Talker device, a Listener device and multiple bridge devices in a bridged audio video (AV) network;
wherein the Talker device sends a Stream Reservation Protocol (SRP) SRP Talker Advertise message for streaming data to the Listener device, the Talker Advertise message including communication path information from the Talker device to the Listener device;
wherein a communication path from the Talker device to the Listener device is selected based on said path metrics, for streaming data between the Talker device and the Listener device.

25. The system of claim 24, wherein the Talker Advertise message includes information about available bandwidth comprising:
Downstream BW (Bandwidth),
Upstream BW,
Downstream available BW,
Upstream available BW,
PER,
Link type,
Latency,
Hopcount,
Currently admitted Stream IDs.

26. The system of claim 24, wherein:
at each device port on a communication path between the Talker device and the Listener device, the Talker Advertise message is processed by appending additional network bandwidth information to the Talker Advertise message.

27. The system of claim 26, wherein:
the Listener device receives the Talker Advertise message indicating end-to-end available bandwidth on a communication path from the Talker device to the Listener device.

28. The system of claim 26, wherein:
the Listener device receives multiple Talker Advertise messages, each Talker Advertise message indicating end-to-end available bandwidth on a communication path from the Talker device to the Listener device.

29. The system of claim 28, wherein:
the Listener device utilizes said Talker Advertise messages from said Talker device for a particular stream, to select a particular path based on the path metrics suitable to meet the streaming.

30. The system of claim 29, wherein:
the Listener device indicates said selection to the Talker device wherein intermediate nodes allocate and reserve the resources for the particular ensuing stream.

31. The system of claim 30, wherein:
the Listener device sends a message to the Talker device about bandwidth to be allocated, the listener message including a list of links in the selected communication path.

32. The system of claim 28, wherein the Listener device selects a backup communication path for said stream.

33. The system of claim 24, wherein the bridged network comprises an Audio Video Bridging (AVB) network of AV devices.
